(19) United States
(12) Patent Application Publication
(10) Pub. No.: US 2003/0018531 A1
(43) Pub. Date: Jan. 23, 2003

(54) Point-of-sale commercial transaction processing system using artificial intelligence assisted by human intervention

(76) Inventors: Kevin E. Mahaffy, Victorville, CA (US); David B. Mahaffy, Fresno, CA (US); Eric E. Schmidt, Hesperia, CA (US)

Correspondence Address: David P. Gordon, Esq., 65 Woods End Road, Stamford, CT, 06905, US

(21) Appl. No.: 10/151,593

(22) Filed: May 20, 2002

Related U.S. Application Data
(63) Continuation-in-part of application No. 09/657,719, filed on Sep. 8, 2000.

(51) Int. Cl. G06F 17/60

(52) U.S. Cl. 705/16

(57) ABSTRACT

A point-of-sale commercial transaction processing system, particularly suitable for the fast food industry, is provided. The transaction processing system utilizes (1) a customer interaction terminal (CIT) having a video display, an audio speaker, a microphone, and preferably a printer, (2) a computer system in communication with the customer interaction terminal (CIT) and running artificial intelligence routines to process or pre-process verbal requests provided into the microphone of the customer interaction terminal, and (3) a human-controlled response system in communication with the computer system which completes, corrects or verifies requests that cannot be satisfactorily completed by the artificial intelligence routines alone. The human-controlled response system is preferably in communication with the customer interaction terminal (CIT) and the customer via a high speed network connection.

This application is a continuation-in-part of U.S. Ser. No. 09/657,719, filed Sep. 8, 2000, which is hereby incorporated by reference herein in its entirety.

### BACKGROUND OF THE INVENTION

1. Field of the Invention

This invention relates broadly to data processing systems for commercial transactions. More particularly, this invention relates to point-of-sale (POS) registers and systems for communicating therewith to facilitate and expedite the ordering and purchase of food items from a restaurant. Notably, the invention utilizes artificial intelligence to at least partially process transactions, and relies on human intervention where the artificial intelligence is unable to complete the transactions.

2. State of the Art

The concept behind a fast food restaurant is the ability to rapidly fulfill food orders placed by a customer at the restaurant's order placement counter. In the current fast food operation model, a plurality of point-of-sale (POS) registers are located on the counter, and the registers are each operated by a cashier behind the counter to enter a customer's order into the register, for example via a keypad. The order is then communicated, for example orally by the cashier, by printed instructions, or by video display, to employees who prepare and assemble the customer's order. In addition, the purchase price of the order is totalled and the customer provides payment to the cashier. Finally, the order is delivered to the customer, either at the register or in an order pick-up queue.

The primary bottleneck to serving greater numbers of customers is in the processing of the orders (i.e., order taken, payment transaction, and order delivery). Research indicates that profits for a fast food restaurant can be increased by decreasing the transaction time for the orders, such that more orders can be entered in a given time frame. However, using the order system presently in place, order process time has been substantially optimized. Training techniques for cashiers have been refined over the years to arrive at the current techniques. While one manner of increasing the ability to process orders would be to provide additional point-of-sale registers on the order counter and cashiers to operate the registers, counter space is limited. Indeed, fast food restaurants are designed to provide a market researched optimum split between order processing space (customer waiting area and order counter, order fulfillment space (kitchen and order preparation), and dining space. It would not be desirable to disrupt the allocation of space within a fast food restaurant.

A number of systems have been proposed and even attempted in trials which are purported to increase order processing. For example, U.S. Pat. No. 5,235,509 to Mueller et al. discloses a customer self-order system which displays menu items on a touch screen and steps the customer through ordering from various food categories: burgers, fries, salads, drinks, desserts, etc. U.S. Pat. No. 5,845,263 to Camaisa et al. discloses an interactive visual order system which provides information in addition to menu items and price to the customer. For example, the customer can obtain information relating to method of preparation and nutritional content, thereby allowing the customer to make a more informed decision. None of these systems or other alternatives has gained acceptance. It is believed that the failure of the proposed systems all have a common drawback. In a fast food environment, where lines of customers are frequently encountered, some customers may be intimidated or confused by the unfamiliar systems and require employee assistance, which slows down the entire system. An additional drawback to the proposed systems is their inability to effectively promote sales with the degree of success provided by a human cashier. Customers all know the ubiquitous phrase “do you want fries with your order”. The phrase is used so commonly because it effectively increases sales. In addition, the current trend to move customers to an ‘upsized’ order of french fries or soft drink also substantially increases the sales at a restaurant, and any new system must be able to provide such promotional features as effectively as a human cashier. Otherwise, the systems will not gain favor by the restaurant operators and will not be utilized.

### SUMMARY OF THE INVENTION

It is therefore an object of the invention to provide a system which can process a great number of fast food orders.

It is another object of the invention to provide an order system which provides a familiar order experience to the customer.

It is a further object of the invention to provide a fast food ordering system which optimizes the use of order processing space in a fast food restaurant.

It is an additional object of the invention to provide a fast food ordering system in which the numbers of behind-the-counter cashiers may be reduced or even eliminated, thereby providing additional room for order fulfillment such that additional orders may be processed.

Another object of the invention is to provide a fast food ordering system which does not require customer ‘training’ and provides a relatively seamless experience for the customer relative to conventional fast food ordering.

A further object of the invention is to provide a fast food ordering system which effectively promotes products in a manner to increase sales for the restaurant.

It is yet another object of the invention to provide a point-of-sale commercial transaction processing system which is adaptable for use in a variety of commercial industries and establishments.

In accord with these objects, which will be discussed in detail below, a point-of-sale commercial transaction processing system, particularly suitable for the fast food industry, is provided. The transaction processing system utilizes (1) a customer interaction terminal (CIT) having a video display, an audio speaker, a microphone, and preferably a printer, (2) a computer system coupled or integral with the customer interaction terminal (CIT) and running artificial intelligence routines to process or pre-process verbal requests provided into the microphone of the customer interaction terminal, and (3) a human-controlled response system which completes, corrects or verifies requests that cannot be satisfactorily completed by the artificial intelligence routines alone. The human-controlled response system is preferably in communication with the customer interaction terminal (CIT) (and the customer) via a high speed voice over internet protocol (VoIP) or data connection.

According to a preferred embodiment of the invention, the computer system presents on the customer interaction terminal (CIT) a graphic image of a virtual cashier which is programmed to interact graphically and through audio with the customer in a manner to which the customer is accustomed from prior experience with human cashiers in conventional fast food restaurants. That is, the virtual cashier preferably includes an image of a face of cashier which auditorily greets, engages, and prompts the customer to verbally provide the fast food order to the virtual cashier (Hello. Please tell me your order.). The customers verbal orders are received by the microphone of the CIT and transmitted to the computer system where they are processed. As the virtual cashier image is computer generated, the face and other features of the cashier may be human-like or whimsical, and may even be representative of a mascot of the restaurant.

The artificial intelligence routines of the computer system are preferably adapted to process the verbal orders such that a complete fast food order (menu item selection, special preparation requests, eat in or take out, etc.) can be processed. The complete order may require multiple interactions between the customer and virtual cashier; i.e., after the customer orders a sandwich, the virtual cashier can engage the customer and ask whether the customer would like a soft drink and, if so, which size. Furthermore, according to a preferred aspect of the invention, the routines in the computer system which operate the virtual cashier are adapted to follow techniques which are shown to increase restaurant sales. For example, the virtual cashier can ask whether the customer would like french fries with an order, or whether for a nominal additional sum the customer would prefer to upsize the french fries and drink order. In addition, the virtual cashier can promote special offers and provide advertisements.

It is recognized that current state of the art artificial intelligence alone may not be sufficient to satisfactorily complete all fast food orders. As such, according to a preferred aspect of the invention, when the computer system is unable to satisfactorily complete a fast food order via the human customer-artificial intelligence virtual cashier interaction, or at any time upon customer request, a human-controlled response system, preferably located off-site of the CIT, is employed to complete, correct or verify the order by interaction with the customer via the CIT. The interaction of the human-controlled response system is through the graphics and audio of the CIT and is preferably indistinguishable to the customer relative to interaction with the artificial intelligence routines. That is, the customer is preferably unaware of any shortcoming in the AI processing and perceives the order interaction as one continuous interaction even if the response system is utilized within an order. The availability of human intervention permits the use of artificial intelligence even as the state of the art artificial intelligence may not yet be ripe for use in all fast food order transactions.

Once an order has been completely processed, payment may be made at the CIT, using a debit or credit card or cash, and the order is sent to order fulfillment employees who prepare the order. The customer is also directed to a pick-up location and may be given an order number corresponding to his or her order.

Another embodiment is provided particularly adapted for the purchase of tickets to entertainment events.

It will be recognized that the above described systems eliminates the need and space required for traditional human cashiers and, therefore, a greater amount of the order processing space may be devoted to CITs. In addition, CITs may be placed on tables, on walls, at kiosks, at drive-through locations, in portable devices, and at other locations. Furthermore, as the CITs preferably display a face and provide a spoken dialogue with the customer, the customer does not require any particular training to use the system; i.e., use of the system of the invention provides a substantially seamless experience, in terms of ordering, from conventional fast food ordering experiences. The customer interacts in the same manner as he or she has previously with human cashiers. Moreover, the system, while easy to use for the customer, provides substantial novelty which attracts and retains customers.

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic diagram of a point-of-sale commercial transaction processing system according to the invention;

FIG. 2, depicted as FIGS. 2A and 2B, is a flow chart of a first embodiment of implementing the point-of-sale commercial transaction processing system of the invention;

FIG. 3, depicted as FIGS. 3A and 3B, is a flow chart of a second embodiment of implementing the point-of-sale commercial transaction processing system of the invention.

### BRIEF DESCRIPTION OF THE APPENDIX

The enclosed CD-ROM Appendix is incorporated herein by reference. The CD-ROM is in ISO 9660 Macintosh® format and includes the following text files organized into the listed directories:

| | | Size | |
|---|---|---|---|
| Directory | File | (Bytes) | Date of Creation |
| Aidoru | Aidoru.resx | 28K | May 10, 2002 |
| | Aidoru.vb | 76K | May 10, 2002 |
| | AssemblyInfo.vb | 4K | Mar. 8, 2002 |
| | BmpStream.vb | 4K | Mar. 28, 2002 |
| | Common.vb | 4K | May 10, 2002 |
| | Config.resx | 12K | Apr. 5, 2002 |
| | Config.vb | 20K | Apr. 5, 2002 |
| | IdCard.vb | 4K | Mar. 8, 2002 |
| | LoadStatus.resx | 8K | Mar. 21, 2002 |
| | LoadStatus.vb | 4K | Mar. 21, 2002 |
| | NotAvail.bmp | 8K | Mar. 29, 2002 |
| | Promo.vb | 4K | Mar. 8, 2002 |
| | Showroom.vbproj | 16K | May 9, 2002 |
| | Startup.vb | 12K | May 8, 2002 |
| Controls | agentAI.Controls.csproj | 8K | May 13, 2002 |
| | AssemblyInfo.cs | 4K | May 13, 2002 |
| | ScriptButton.cs | 4K | May 13, 2002 |
| | ScriptButton.resx | 4K | May 13, 2002 |
| Raktor | Aidoru.vb | 20K | May 13, 2002 |
| | AssemblyInfo.vb | 4K | Feb. 18, 2002 |
| | Babble.resx | 8K | Feb. 18, 2002 |
| | Babble.vb | 4K | Feb. 18, 2002 |
| | Calendar.resx | 8K | May 13, 2002 |
| | Calendar.vb | 8K | May 13, 2002 |
| | Common.vb | 4K | May 13, 2002 |
| | Ractor.resx | 56K | May 13, 2002 |
| | Ractor.vb | 144K | May 13, 2002 |
| | Test.Ractor.sln | 4K | May 13, 2002 |
| | Test.Ractor.vbproj | 12K | May 13, 2002 |
| | Test.Ractor.vbproj.vspscc | 4K | May 13, 2002 |
| | Test.Ractor.vssscc | 4K | May 13, 2002 |
| VR | ShowroomGrammar.xml | 20K | May 13, 2002 |
| VoIP | agentAI.VoIP.rc | 4K | Jan. 3, 2002 |
| | agent.VoIP.cpp | 8K | Jan. 3, 2002 |
| | agentVoIP.h | 4K | Dec. 26, 2001 |
| | Aidoru.cpp | 8K | Dec. 24, 2001 |
| | Aidoru.h | 4K | Dec. 26, 2001 |
| | AssemblyInfo.cpp | 4K | Dec. 26, 2001 |
| | Ractor.cpp | 8K | Jan. 18, 2002 |
| | Ractor.h | 4K | Dec. 26, 2001 |
| | resource.h | 4K | Dec. 26, 2001 |
| | Stdafx.cpp | 4K | Dec. 18, 2001 |
| | Stdafx.h | 4K | Jan. 3, 2002 |
| | WaveHeader.cpp | 4K | Dec. 19, 2001 |
| | WaveHeader.h | 4K | Dec. 19, 2001 |
| | WaveIn.cpp | 4K | Dec. 19, 2001 |
| | WaveIn.h | 4K | Dec. 19, 2001 |
| | WaveOut.cpp | 4K | Dec. 19, 2001 |
| | WaveOut.h | 4K | Dec. 19, 2001 |
| Theater | agentAI.Theater.vbproj | 8K | Apr. 17, 2002 |
| | AssemblyInfo.vb | 4K | Apr. 10, 2002 |
| | IAidoru.vb | 8K | May 8, 2002 |
| | IRactor.vb | 4K | Apr. 17, 2002 |
| | Seat.vb | 8K | May 6, 2002 |
| | SeatCollection.vb | 8K | May 6, 2002 |
| | Show.vb | 4K | May 6, 2002 |
| | ShowCollection.vb | 8K | May 8, 2002 |
| | Table.vb | 4K | May 6, 2002 |
| | TableCollection.vb | 4K | May 6, 2002 |
| | Theater.vb | 4K | May 2, 2002 |
| SeatingChart | agentAI.SeatingChart.csproj | 8K | Apr. 27, 2002 |
| | AssemblyInfo.cs | 4K | Apr. 26, 2002 |
| | SeatingChart.cs | 16K | May 8, 2002 |
| | SeatingChart.resx | 4K | Sept. 20, 2001 |

These files comprise the source code for components of a ticket selection and dispensing point-of-sale transaction system according to a preferred embodiment of the invention.

### DETAILED DESCRIPTION OF THE PREFERRED EMBODIMENTS

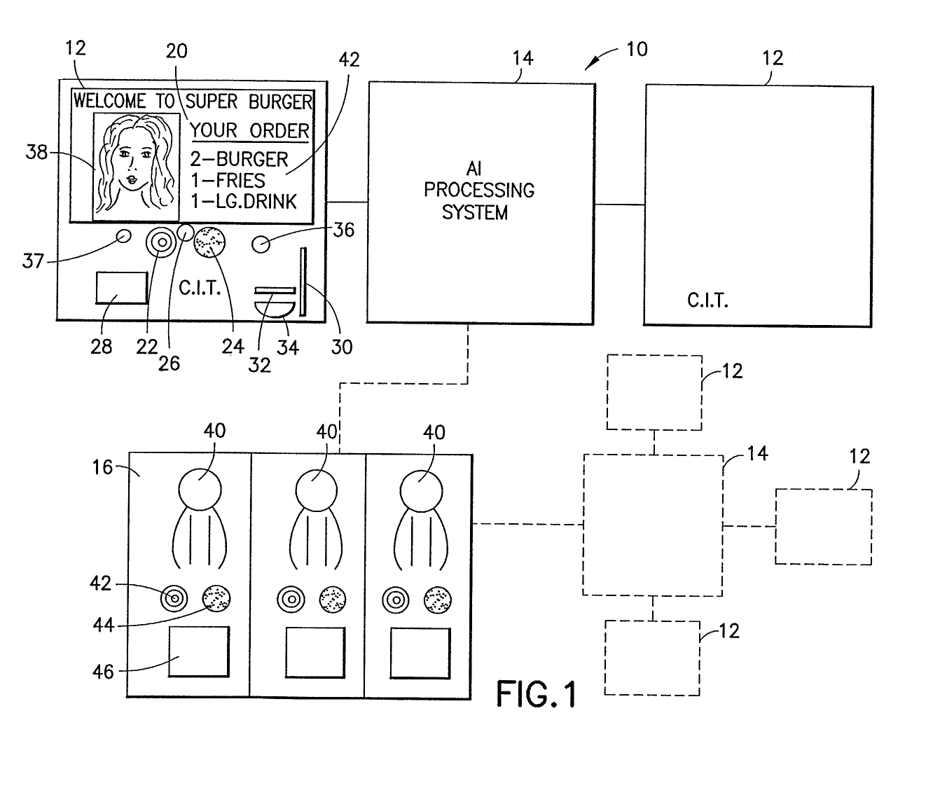

Turning now to FIG. 1, a point-of-sale commercial transaction processing system 10 particularly suited for a fast food establishment is provided. The transaction processing system includes a customer interaction terminal (CIT) 12, a computer system 14 coupled to the CIT, and a human-controlled response system 16 in communication with the computer system 14.

The CIT 12 includes a video display 20, an audio speaker 22, a microphone 24, and optionally a video camera 26. In addition, the CIT 12 also preferably includes a printer 28, a debit/credit card reader 30, and a bill and/or coin currency reader 32 as well as a change dispenser 34. The CIT may also include an activation button 36, such as a ‘push-to-talk’ button, and may further include a sensor 37, e.g., an infrared or sonic sensor, which senses when a customer is located in an “ordering” position relative to the CIT. As an optional alternative, the video camera 26 may function as the sensor. The CIT 12 is located in a fast food restaurant. The CIT 12 may be placed on a counter, in a kiosk, on a wall, at a dining table, along a take-out drive-through route, in a portable device which may be transported along a drive-through route, or in any other suitable location within or relative to a fast food restaurant enabling customer interaction with the CIT.

The computer system 14 is coupled to or integral with one or more CITs and is adapted to receive input from the CITs 12 (via the microphone 24 and optional video camera 26) and provide output to the display 20, audio speaker 22, and printer 28 of the CIT. That is, the CIT 12 is under the control of the computer system 14. In addition, the computer system 14 preferably includes a memory adapted to record the audio and optionally the video portion of a current interaction between a customer and a CIT. While multiple CITs 12 may be coupled to a single computer system 14 (two CITs 12 being shown in solid lines in FIG. 1), for clarity, the invention will be described with respect to a single CIT 12 being coupled to the computer system 14. The computer system 14 has software adapted to permit each CIT 12 to ‘interact’ with a customer and process (via artificial intelligence routines) customer orders spoken into the microphone 22, as described in more detail below, and a microprocessor adapted to run the software.

The human-controlled response system, e.g., a call center 16, is connected to the computer system 14 (or multiple computer systems 14, each, in turn, coupled to one or more CITs 12). The call center 16 is preferably located on different premises than the CIT 12 and computer system 14, and more preferably located in a country or region having a relatively lower labor cost than the country or region in which the CIT is located. A number of human operators 40 work at the call center, and each operator is provided with an audio speaker 42, a microphone 44, and a display 46. The audio speaker 42 is adapted to reproduce for the operator 40 sounds (words) spoken into the microphone 24 of the CIT and/or recorded by the computer system 14, the microphone 44 is adapted to permit the operator to provide spoken messages to the customer via the speaker 22 of the CIT, and the display 46 permits the operator to see the customer's order, and preferably displays the same images shown on the display 20 of the CIT.

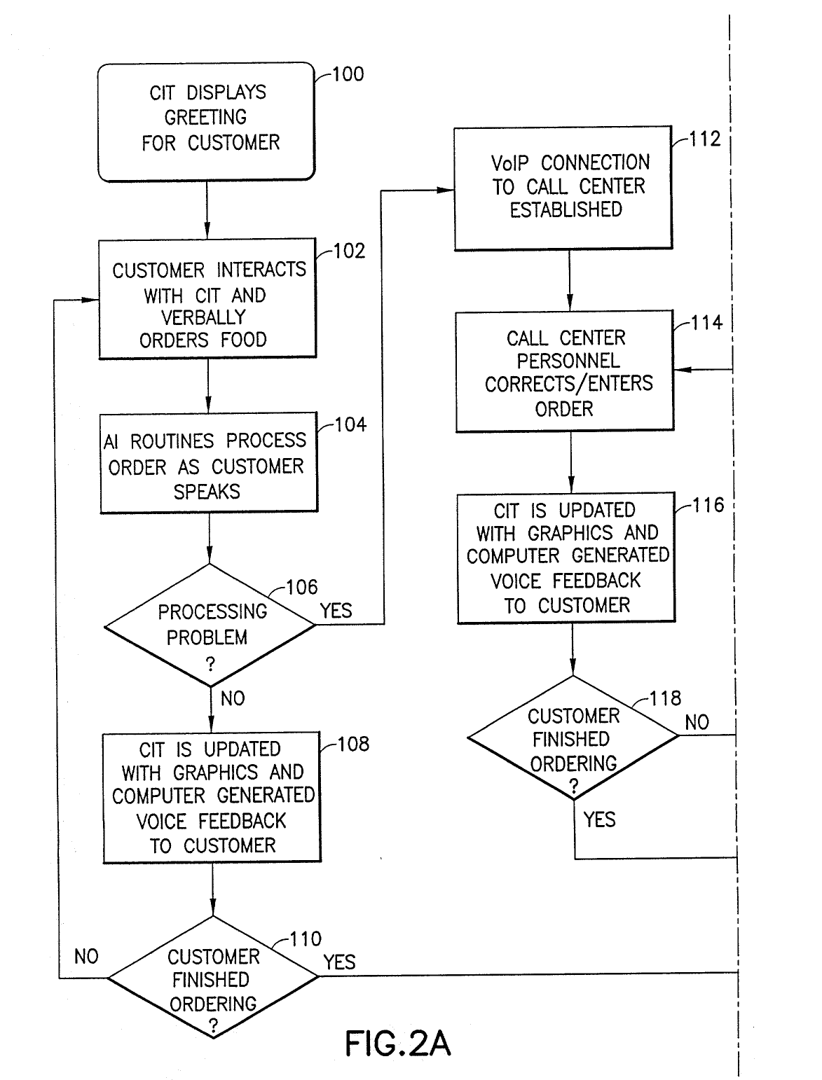

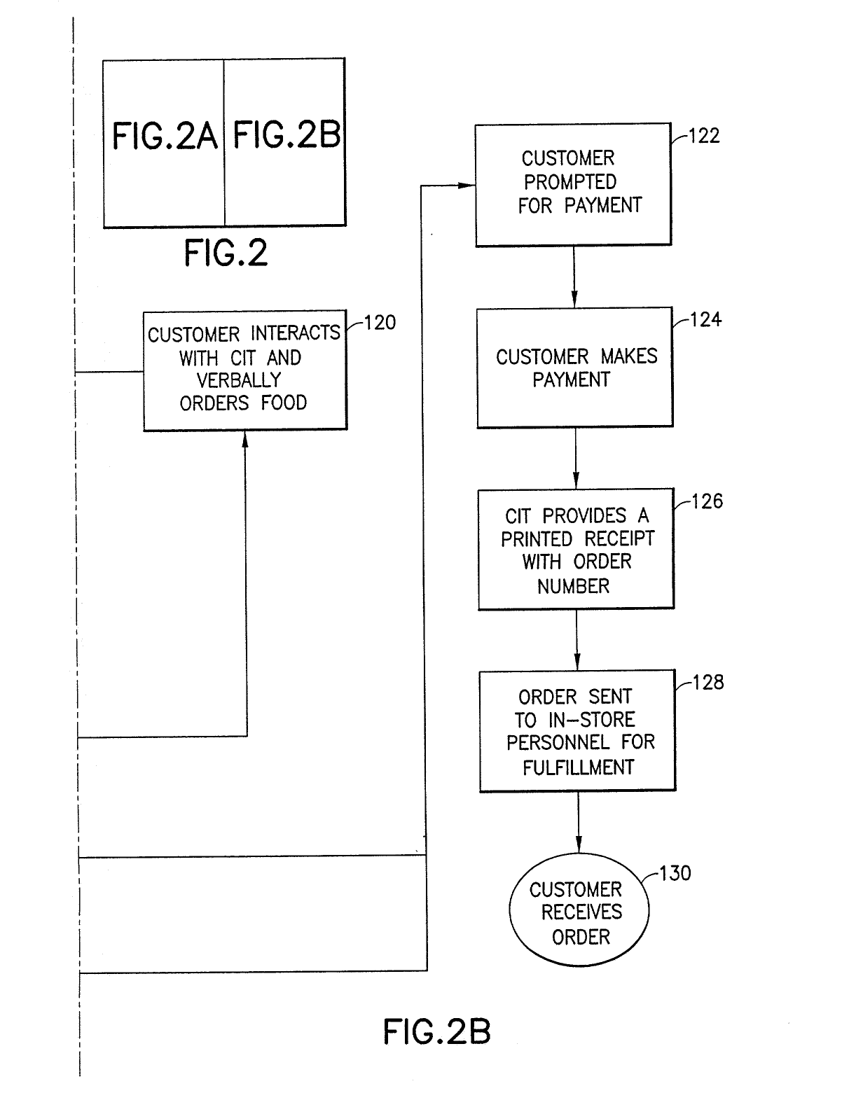

Referring to FIGS. 1 and 2, the software permitting the CIT 12 to ‘interact’ with customers includes a graphic image of a virtual cashier 38 programmed to interact graphically and through audio via the microphone 22 and speakers 24 with the customer interfacing with the CIT 12. The images of the virtual cashier are preferably computer generated and, as such, the face and other features of the cashier may be human-like, animal-like, or whimsical in nature, and may even be representative of a mascot of the restaurant (e.g., Ronald McDonald) or characters in a movie or television show. Human-like features may be representative of celebrities. The interaction is preferably performed in a manner similar to that which the customer is accustomed from prior experience with human cashiers in conventional fast food restaurants. That is, the virtual cashier preferably displays images of a face of cashier and auditorily greets, engages, and prompts at 100 the customer to verbally provide a fast food order to the virtual cashier (e.g., “Hello. Please place your order with me.”). The customer's verbal orders are received by the microphone 22 of the CIT and transmitted to the computer system 14 where they are processed, as described below.

According to a preferred embodiment of the order processing software, when a customer order is verbally provided into the microphone 22 of the CIT at 102, the order is provided to the computer system 14 and the artificial intelligence routines are adapted to process at 104 the customer's order in real time. That is, the artificial intelligence (AI) routines are adapted to parse from the orders the necessary content to determine what the customer wants to order.

The ability of the AI routines to satisfactorily process customer orders at 104 depends on the amount of variability present in the process; i.e., the extent to which the vocabulary and the grammar used in the interaction varies from one customer to another. The AI routines are preferably optimized based on conditioning data collected from conversation over a period of time (e.g., a few days) at a conventional cashier point of sale terminal and examined for recurring patterns, and then used to train the AI routines. AI routine training and optimization is preferably performed on a continual basis, with reports of misunderstood communications regularly analyzed and used to improve the performance of the system.

An important issue for automating customer interaction with the CIT is to distinguish between customer-CIT interaction speech and other speech, e.g., utterances by the customer to other people in the vicinity, or even “talking to oneself”. One simple approach to overcome this difficulty is to use a push-to-talk button 36, as described in J. Gustafson, N. Lindberg, and M. Lundeberg, “The August Spoken Dialogue System”, Proceedings of Eurospeech 99 (1999). Another preferred approach is to use the optional video camera 26 to track the customer's head orientation and gaze (head tracking), and only respond to utterances made when the user is looking directly at the CIT. The problem of pose recognition (i.e., recognizing, from a camera image, whether a person's face is oriented towards the camera) is not very difficult. For example, standard machine learning techniques can be used. First, a training corpus of faces is constructed, with examples of faces looking at the camera and faces looking elsewhere. Second, the system is trained to learn an algorithm which distinguishes between the two. Finally, the resulting classifier is applied to new faces. Reasonable success has been achieved on the pose recognition task using neural networks. T. Mitchell, Machine Learning, McGraw Hill (1997). More modern classifiers, such as support vector machines can be used to achieve even higher accuracy. C. Burges, “A Tutorial on Support Vector Machines for Pattern Recognition”, Data Mining and Knowledge Discovery, Vol. 2, Number 2, p. 121-167 (1998). There are also approaches based on template matching which may be used. B. Scassellati, “Finding Eyes and Faces with a Foveated Vision System”, Proc. 15th National Conference on Artificial Intelligence (AAAI-98), AAAI Press (1998).

Tracking the customer's head orientation is user-friendly, especially in drive-through settings, where the customer would otherwise have to extend his or her hand from the car to push the button 36. However, it is also more prone to error, particularly for nonstandard facial configurations (e.g., men with a heavy beard or people wearing a baseball cap). When the head tracking approach is used, it is preferable that the CIT 12 indicate to the customer when the system interprets that the customer's spoken words are aimed at the system. Where the interaction is based on animated characters, the indicator can be entertaining. For example, if the system is not listening to the spoken words of the customer, the character can pretend to be sleeping. Then, when the customer is communicating with the system, but the system fails to recognize the communication, the manual push-to-talk button can be used as a fall-back.

Current speech recognition systems are effective in one of two modes: either there is a single speaker, for which the system can be individually trained to understand a relatively large vocabulary; or there can be multiple speakers for which current systems can recognize a limited vocabulary. For the system of the invention, the vocabulary required is likely to be quite limited, thereby making high-accuracy speech recognition feasible for use by multiple users. For example, in another application of a restricted-domain automated dialogue system, a vocabulary of 500 words was sufficient. See Gustafson et al. (1999).

Currently existing on the market are several high-quality commercial speech recognition systems: Dragon's NaturallySpeaking™, Kurzweil Applied Intelligence's L&H Voice XpresS™, and IBM's ViaVoice™. These speech recognition systems are primarily designed for single speaker, large vocabulary settings. However, the systems may be modified for use in a multiple speaker, limited vocabulary setting. Another option is to utilize a speech recognition tool kit with a developer's application programming interface (API) that allows the vocabulary and other aspects to be tailored to the fast food ordering process (See http://www.speech.cs.cmu.edu/comp.speech/FAQ.Packages.html for links to available packages.) In addition, an existing public domain speech recognition system may be adapted, or a system may be implemented from scratch. See Gustafson et al. (1999) for details on how this can be done.

An important issue is the ability of the AI routines of the computer system 14 to recognize when the result of the speech recognition is correct and, when it is incorrect, to cause the system to ask the customer for a clarification or cause intervention by a human operator, as described further below. Several approaches can be used for estimating this confidence. All current speech recognition systems use an underlying probabilistic model, so they can be adapted to output the probability of the acoustic signal given the recognized words. In other words, this number estimates how likely this particular word sequence is to have generated the acoustic signal heard. If this number is low, this is an indicator of possibly faulty recognition. A possible improvement to this approach is to also generate a second probability of the acoustic signal given a syllable-based recognition system that does not try to match words. See Gustafson et al. (1999). If the second probability is substantially higher than the first, then the utterance contained words outside the vocabulary of the speech recognition system's lexicon that the system “forced” into words in the lexicon.

As the AI routines processes the words of the customer's order, the task is to recognize the customer's request at a level sufficient to process his order. There are several approaches to this task, of increasing complexity on the one hand, but probably higher accuracy rates on the other. The simplest approach is to use no semantic processing, just recognition of basic menu items. In this case, the analysis is a direct result of the speech recognition. If one recognizes the words “three” and “SuperBurgers” in an utterance, this is interpreted as an order of three SuperBurgers. This approach will work for simple menu orders, but may be too limited to many cases, as it may not be able to deal with any extensions such as “without pickles”, “extra mustard”, etc.

A second level is to generate a corpus of utterances that are likely to occur in a customer-CIT interaction. One can then compare the customer utterance to others in the database, and find the closest match. This is the approach discussed in Gustafson et al. (1999). A semantic interpretation, i.e., a mapping between the sentence structure and an order form, can then be manually constructed for each template sentence. The extent to which this approach can be successful depends, as discussed above, on the variability of utterances that occur.

The next level is to actually parse the sentences using some type of grammar. There has been substantial improvement in the last five years in parsing (See C. Manning and H. Schutze, Foundations of Statistical Natural Language Processing, MIT Press (1999)), including a recent account of parsing a large corpus of speech utterances. See E. Charniak, “The Statistical Natural Language Processing Revolution”, colloquium talk given at Stanford University, Apr. 26, 2000 (see http://robotics.stanford. edu/ba-colloquium/previous/spring00/abst-charniak.html. The parsing uses a grammar, preferably learned automatically from a corpus of utterances parsed manually. As discussed in L. Bell and J. Gustafson, “Interaction with an Animated Agent in a Spoken Dialogue System”, Proceedings of Eurospeech '99 (1999), the number of grammatical variations in automated dialogue systems is usually quite small, and the grammar is quite simple. Again, it is easiest to manually provide a semantic interpretation for each grammatical 'structure, as above.

A difficult problem is the treatment of anaphoric references, of the form: “actually, cancel that and give me two orders instead”. It is difficult to relate the words “that” and “instead” to particular items used in previous utterances. There has been some success in automatically clarifying anaphoric references (See E. Charniak, N. Ge, and J. Hale, “A Statistical Approach to Anaphora Resolution”, Proceedings of the Sixth Workshop on Very Large Corpora(1998)), but this is still a difficult problem. As such, the AI routines are preferably adapted to clarify the references by having the CIT ask the customer “what do you mean?”, or by causing intervention by a human operator 40, discussed below.

If the AI routines are able to recognize and parse the speech of the customer (as preferably determined via a probabilistic calculation) such that individual menu items ordered are properly added to the customer's order list (the transaction) after each menu item is ordered, the CIT is updated at 108 (and 42 in FIG. 1) to affirm order recognition. The update preferably includes one or more of three subtasks: text generation, voice generation, and animation generation. The text is preferably displayed in a predetermined set of grammatical forms, filled in with the details of the customer's transaction. Voice generation to interact with the customer may be based on automated speech synthesis. However, given the limited number of words that the CIT would need to reproduce, it is preferable that CIT speech to a customer be provided using pre-recorded words. Known smoothing techniques are preferably used to provide a natural sounding transition between the reproduced pre-recorded words. The virtual cashier's face is animated to correspond to the words being ‘spoken’ by the virtual cashier. This can be done by one of two approaches. The simpler approach is a ‘manual’ approach in which, for human characters, a human actor prerecords all the words which may need to be spoken and, using standard morphing techniques, the transitions between words are smoothed. For cartoon characters, each word can be animated and the same morphing technique can be used for the transition.

A more complex approach permits more sophisticated interactions. In this approach, a computer-generated character is animated based on an actor's rendition of the same word. The actor says a word with certain markers on his face, capturing the main articulation points. The articulation points are then mapped onto corresponding points for the cartoon character, allowing the character's animation to mimic the actor's expression. Again, simple morphing can be used to deal with the inter-word transitions. See, for example, F. Pighin, J. Hecker, D. Lischinksi, R. Szeliski, and D. Salesin, “Synthesizing Realistic Facial Expressions from Photographs”, Proceedings of Siggraph (1998), and M. Brand, “Voice Puppetry”, Proceedings of Siggraph '99 (1999). In addition, basic emotional affect and other interactive changes to the facial animation can be incorporated. For example, the eyes of an animated character can follow the customer using feedback from the video camera 26. See Gustafson et al. (1999) and Pighin et al. (1998).

In addition, the CIT 12 may prompt the customer via computer-generated voice or displayed text to add other items to the menu list, and a complete order may require multiple interactions between the customer and virtual cashier 38; i.e., after the customer orders a sandwich, if the customer does not on his or her own add additional menu items within a predetermined time period, e.g. two second, the virtual cashier engages the customer and asks whether the customer would like a soft drink and, if so, which size. Furthermore, according to a preferred aspect of the invention, the routines in the computer system which operate the virtual cashier are adapted to follow additional techniques which are shown to increase restaurant sales. For example, even after the customer indicates that his or her order is complete, the virtual cashier preferably asks whether the customer would like french fries with an order which does not already include french fries, or whether for a nominal additional sum the customer would prefer to upsize the french fries and drink order, e.g., from medium to large. Furthermore, at any time during the order process, the virtual cashier can promote special offers and provide advertisements for products in the restaurant establishment or for products from outside establishments. Additional menu items orders are processed at 104 and the CIT is updated at 108 until the customer indicates at 110 that the order is complete.

If at any time during the customer's order placement there is a problem with the order processing at 106, as preferably determined via a probabilistic calculation, (and optionally at any time upon request by the customer, e.g., by pressing a button or by verbal request), a network connection is created at 112 between the CIT 12 (and computer system 14) and the call center 16. The network connection may be a high speed voice over internet protocol (VoIP) connection permitting the transmission of the customer's voice order quickly and inexpensively to an operator 40 at the off-site call center 16. Additionally or alternatively, the connection may be a high speed data connection, and the customer's recorded verbal order is sent from the memory of the computer system 14 to the audio speaker 42 directed at the operator 40. The operator 40 is able to correct, verify or complete the customer menu orders at 114. As the operator makes the required changes or additions, the CIT is updated at 116 to indicate the changes and additions and provide feedback to the customer. Whether the AI routines or an operator is interacting with the customer, according to the preferred embodiment of the invention, it is desirable that the customer receive the same manner of interaction so that the customer is unaware when an operator 40 has intervened. As such, instructions by the operator 40 to the CIT 12, at 116, preferably result in the same type of CIT updating (text, speech, and animation) as when the AI routines alone interface with the customer and, until the order is complete at 118, the customer continues his or her food order by speaking to and otherwise interacting with the virtual cashier 38 on the CIT at 120. The operator preferably interacts with the CIT and the customer by inputting keyboard commands, mouse, or voice commands which cause a preprogrammed automated update responses at the CIT. If the operator needs to respond outside the capability of the preprogrammed responses, the operator preferably speaks into the microphone 44 and the speech is converted to text by voice recognition. The recognized speech is filtered to remove unwanted accents and words and to provide smoothing, and data corresponding to the speech is sent to the computer and then synthesized by the CIT or used to trigger recorded words in memory of the CIT. According to the first embodiment of the invention, once the connection is made with the call center at 112, the operator 40 is utilized to complete the order with the customer without reversion to the AI routines.

Once the order is complete at 118, the customer is prompted at 122 for payment which is preferably made at the CIT. Payment is made at 124 using a debit card or credit card in conjunction with the card reader 30, or with cash in conjunction with the bill reader 32 and change dispenser 34. After payment is made, the CIT prints at 126 with the printer 28 a receipt for the customer indicating the details of the order as well as an order number, and the virtual cashier directs the customer to proceed to an order pick-up area. In conjunction with order payment and receipt printout, the order is sent at 128 to order fulfillment employees (kitchen staff and order assembly personnel) who prepare the order. The orders are packaged with the respective order number and, once complete, the customer is provided at 130 with the customer's corresponding order.

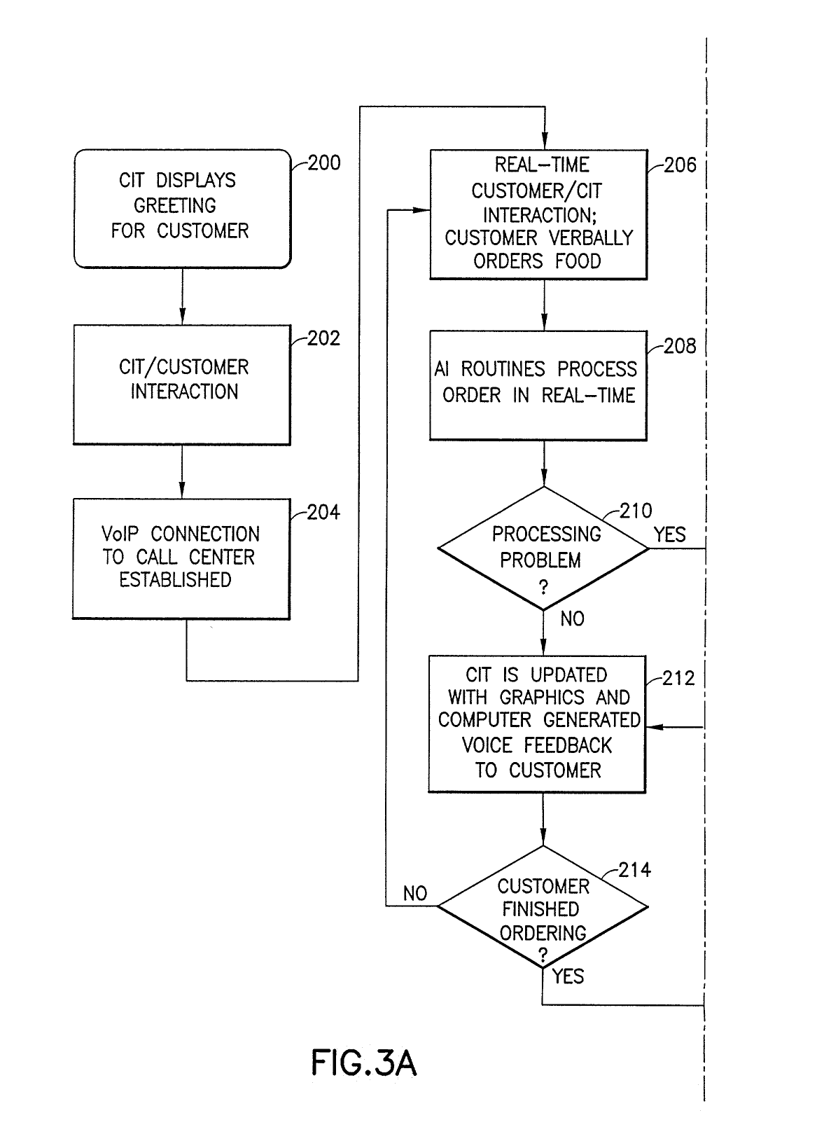

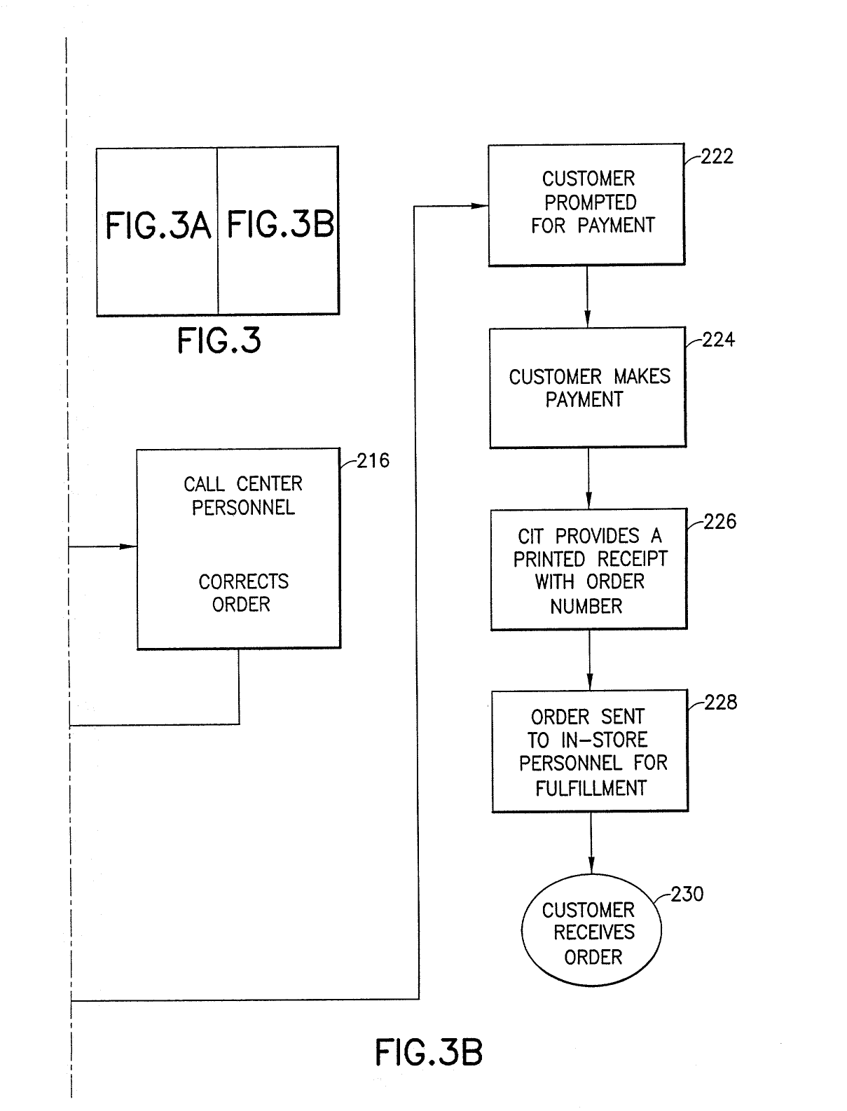

Turning now to FIGS. 1 and 3, a flow chart for a second preferred embodiment of the invention is shown. The second embodiment is substantially similar to the first embodiment, with the following differences. A CIT greeting is provided at 200 which, rather than prompts the customer to place an immediate order (as in the first embodiment), requests whether the customer would like to place an order, e.g., “Hello, would you like to place an order.” This request is intended to cause an initial “,Yes” response or other CIT-customer interaction from the customer, at 202, prior to order placement and provide a short delay prior to order entry which is sufficient for establishment at 204 of a connection to the call center 16. Alternatively, the connection may be made upon indication by a sensor 37 which senses the presence of customer ready to place an order. As yet another alternative, a constant connection may be maintained between the CIT 12 and the call center 16 and the CIT greeting may be intended to cause immediate order placement by the customer.

In either approach, the customer then interacts at 206 with the CIT 12 in real-time, verbally ordering food. The AI routines in the computer process the interaction at 208 to parse and identify the elements the food order. Assuming there is no problem with the processing at 210, after each menu item is ordered, the CIT is updated at 212, and the AI routines continue to process the order until the order is complete at 214. However, if there is a problem at 210 during any of the AI processing, the order is assigned to an operator 40 at the call center 16, and the operator corrects the order at 216, and the CIT is then updated at 212. According to the second embodiment of the invention, if the customer order is incomplete at 214, the AI routines are again given responsibility at 208 for processing the interaction between the customer and CIT at 206 and maintains control absent another processing problem at 208. This is in contrast to the first embodiment, where after the occurrence of a processing problem an operator is given responsibility for not only correcting the problem but completing the order.

Once the order is complete at 214, the steps of prompting the customer for payment through providing the customer with the order (that is, steps 222-230) are the same as the analogous steps in the first embodiment (steps 122-130).

While the above described transaction processing system is optimized for use within a fixed location, such as the order processing space of a fast food restaurant, it will be appreciated that the CIT may be optimized for drive-through use and adapted to be handed to the customer or taken from a station at the beginning of a drive-through route. In order to avoid driving accidents due to diverted attention while using the portable CIT, the portable CIT preferably includes an accelerometer, which allows the unit, as well as an operator at the call center, to know whether the customer's vehicle is in motion. The CIT is optionally programmed to not interact with the customer while the vehicle is in motion. For example, the portable CIT can repeat a message to ask the customer to continue the ordering process once the vehicle is stopped. The portable CIT is preferably formed to fit within a standard cup holder found in most cars, and the top of the portable CIT is preferably provided with a small display screen which preferably alternately displays the virtual cashier and a screen that lists the menu items being ordered. The portable CIT preferably contains a debit/credit card reader to facilitate and expedite payment. The portable CIT optionally includes a compartment in which the customer can place paper and coin currency. The portable CIT is returned to a restaurant employee at the time of order pickup. If the customer pays with cash, the employee will remove the cash from the compartment in the CIT and give change to the customer. Finally the customer receives the food ordered.

Another option is for the CIT to be an all audio-based device, without a display component. The benefits of such a CIT is that the hardware and software for the device are cheaper and more reliable. One exemplar all audio-based CIT eliminates the speaker and preferably includes written instructions directing the customer to tune a car radio to a particular frequency. The CIT then broadcasts the virtual cashier's voice into the car through the car's radio and speaker system. This may be done by adapting the CIT such that when it is placed near the car radio, it automatically sends the audio signal over the car's radio system. Transmission of audio signals through the radio in this manner is known for common audio devices such as MP3 players. In addition, rather than include a microphone, the words spoken by the customer are received by means of a laser incident on the windshield or driver side window of the car. The laser detects the vibration of the glass caused by the customer's spoken words and then reconvert this vibration signal back into an audio signal. This technology, developed for espionage purposes, is now widely available. The advantage of this approach is that it minimizes the need for extra hardware to be produced and then put at risk by placing it into the hands of the customer where it potentially may be damaged or stolen.

If multiple CITs are distributed to drive-through customers, it is preferable that each is linked to a central server in the restaurant by wireless networking technology, e.g., such as the Bluetooth™ standard. In addition, it is preferred that the portable CITs be used in conjunction with a system which prevents or inhibits accidental or purposeful removal of the CIT from the restaurant property. As such, when the unit is removed from the restaurant property, the unit is preferably adapted to make an alarm sound and warn the customer to return the CIT unit. The restaurant staff is likewise alerted and a digital or film photograph is preferably taken of the car (including the license plate) to aid in law enforcement action recovery. The portable CIT preferably informs the customer that a picture has been taken of their car and instructs the customer to return the unit to the restaurant. The CIT may also send out a tracking signal, e.g., GPS coordinates, permitting the CIT to be located.

While the transaction processing system has been specifically described above with respect to the operations of a fast food restaurant, it will be appreciated that the system may be used in other industries which have conventionally used a point-of-sale register. For example, and not by way of limitation, the system is suitable for use in the rental car industry and for the purchase of tickets to entertainment events such as concerts, theater events, and movies.

More specifically, according to one implementation of the invention, a software package has been developed that combines a number of technologies to implement human-assisted artificial intelligence. Off-the-shelf speech recognition, text-to-speech (TTS), and presentation technologies, along with a sophisticated graphics engine and internet technologies, and proprietary software components (the source code of which is provided in the Appendix), combine to give a near-human sales experience, with the Microsoft® .NET framework being used incorporate the technologies.

A currently preferred presentation engine is the Haptek Player by Haptek, Inc., which uses the Virtual Friend™ technology. Through pre-recorded voice and TTS voice responses, the Haptek player responds to a customer's requests. The customer's requests are discerned through the Microsoft® Speech Application Programming Interface, version 5.1 (SAPI 5.1), where some of the artificial intelligence resides. If SAPI fails to recognize or properly discern the customer's request, the request is forwarded through internet protocols to a remote human assistant. Proprietary artificial intelligence routines manage unrecognized requests.

The software package also manages product choices and interfaces with back office software that records and tracks orders. For example, in a system adapted for sales of tickets to entertainment events, the software package preferably interfaces with WinTix™ and TixPrO™ products of Center Stage Software. For credit card verification, the software package functions as a front end to the PCAuthorize® credit card verification software. Credit card approval, signature capture, and verification of customer identification are all assisted by the proprietary components of the software package.

The software package is preferably written in Microsoft C++, C#, and Visual Basic.NET, and the Microsoft .NET framework provides a rich infrastructure for the demanding requirements of the software package. A custom Voice over Internet Protocol (VoIP) engine, set forth in the Appendix, is written in unmanaged C++ with a managed C++ wrapper utilizing Microsoft's Windows System Application Programming Interfaces for Multimedia (MMSystem API). Several ActiveX components are preferably used as well including the Haptek Player ActiveX interface from Haptek Inc., an ActiveX interface to WinTix/TixPro. In addition, Videum™ by Winnov is preferably utilized for control for video capture, and Microsoft's Comm Lib is used for serial communication with credit card readers. Microsoft DirectX is preferably used for additional multimedia-related functions. Active Data Objects (ADO) and ADO.NET available from Microsoft are preferably used for accessing and manipulating data. Also preferably used is the Infragistics™ UltraWinSchedule™, a .NET component used to assist in date- and time-sensitive sales.

In such a system, the CIT is preferably adapted to display seating charts of various venues to a customer, permits seat selection, and prints and dispenses tickets to the customer upon completion of the sale. The steps are preferably conducted all by artificial intelligence routines, but, at any time, a remotely-located human may intervene to complete or correct all or a portion of the transaction. In order to facilitate completion of the transaction, it is preferable that the CIT include a financial card reader (e.g., credit card, debit card, smartcard, etc.), optionally an additional identification card reader, and a digital signature pad for input of a customer signature in electronic form to authorize the transaction.

It will be recognized that the above described systems and methods eliminate the need and space required for traditional human cashiers and, therefore, provide a greater amount of the order processing space for CITs. Furthermore, as the CITs preferably display a face and provide a spoken dialogue with the customer, the customer does not require any particular training to use the system; i.e., use of the system of the invention provides a substantially seamless experience, in terms of ordering and processing, from conventional point-of-sale, and particularly fast food ordering and ticket purchase, experiences. The customer interacts in the same manner as he or she has previously with human cashiers. Moreover, the system, while easy to use for the customer, provides substantial novelty which attracts and retains customers.

There have been described and illustrated herein several embodiments of a point-of-sale commercial transaction processing system, and one particularly suited for use in a fast food restaurant. While particular embodiments of the invention have been described, it is not intended that the invention be limited thereto, as it is intended that the invention be as broad in scope as the art will allow and that the specification be read likewise. Thus, while particular elements of the CIT have been disclosed, it will be appreciated that other elements may be included or removed, provided that the CIT is capable of permitting verbal input from the customer which can then be at least partially processed by AI routines in a computer. Furthermore, while in the first embodiment, the operator once given control of a portion of a customer order retains control of the order, it will be appreciated that the system can be operated permit the AI routines to regain control of an order. In addition, while particular orders of the method of the invention have been shown and described with respect to the flow charts, it will be appreciated that another order may be used, and that the two flow charts are exemplary. Furthermore, while the display is shown with a virtual cashier and details of an order, it will be appreciated that the display can display advertising (of the establishment in which it is being used, or of another establishment, and promotions of the establishment). Such displays of advertising and promotions can occur during an order transaction or while the CIT is idle waiting for a customer to interact with the CIT. Moreover, while it is recognized that conversion of an audible customer instruction into a digital signal is a relatively convenient manner by which to provide instruction to the AI processing routines, it is appreciated that technology adapted to read customer lips from the video signal can also be used, and may be preferred where large amounts of background noise create difficulties in discerning the customer instruction. It will therefore be appreciated by those skilled in the art that yet other modifications could be made to the provided invention without deviating from its spirit and scope as claimed.

1. A point-of-sale ticket vending system for processing a customer transaction based upon a verbal instruction from the customer, comprising:
a) a first customer interaction terminal (CIT) adapted to receive the verbal instructions from a customer as to which event the customer seeks to purchase tickets, and convert the verbal instruction into an audio signal;
b) a first computer system in communication with said first CIT and including an artificial intelligence (AI) system which receives said audio signal and processes said audio signal to at least partially recognize the verbal instruction from the customer;
c) a display on which said first computer system displays seating charts and lists available seats for events; and
d) a human-controlled response system in communication with said first computer system and adapted intervene to interact with the customer when said AI system has not satisfactorily recognized the verbal instruction from the customer.

2. A point-of-sale ticket vending system according to claim 1, wherein:
said first CIT further includes a ticket printing system.

3. A point-of-sale ticket vending system according to claim 1, wherein:
said first CIT is adapted to provide to the customer at least one of an audio and video confirmation that the verbal instruction was recognized.

4. A point-of-sale ticket vending system according to claim 1, wherein:
said computer system animates a character on said display of said first CIT which interacts with the customer.

5. A point-of-sale ticket vending system according to claim 1, wherein:
said first CIT includes a payment system.

6. A point-of-sale ticket vending system according to claim 1, wherein:
said first CIT includes a video camera.

7. A point-of-sale ticket vending system according to claim 1, wherein:
said human-controlled response system is off-premises relative to said first CIT and said first computer system.

8. A point-of-sale ticket vending system according to claim 1, further comprising:
a financial card reader adapted to receive a financial card to effect payment for the ticket.

9. A point-of-sale ticket vending system according to claim 8, further comprising:
a signature pad for input of a customer signature in electronic form to authorize payment for the ticket.
